(19) United States
(12) Patent Application Publication
(10) Pub. No.: US 2026/0339758 A1
(43) Pub. Date: Oct. 29, 2026

(54) System and Method to Enable High Performance Between Python and Web Applications

(71) Applicant: NATIONAL INSTRUMENTS CORPORATION, Austin, TX (US)

(72) Inventor: Christopher G. Cifra, Austin, TX (US)

(21) Appl. No.: 19/657,230

(22) Filed: Apr. 24, 2026

Related U.S. Application Data
(60) Provisional application No. 63/794,775, filed on Apr. 25, 2025.

(51) Int. Cl. G06F 9/54

(52) U.S. Cl. CPC G06F 9/541

(57) ABSTRACT

Systems, methods, and computer-readable memory media for interworking between measurement function and JavaScript™ workflows. A measurement script is provided to a measurement device to perform a first measurement, and first measurement results of the first measurement are received from the measurement device. The first measurement results are translated into a JavaScript™ Object Notation (JSON) text string, and both the JSON text string and the untranslated first measurement results are stored in a shared memory medium. A software module retrieves the JSON text string from the shared memory medium. The software module utilizes the JSON text string to display the first measurement results on a display device, and/or receive user input to modify parameters of the first measurement script for provision back to the measurement device for performing a modified second measurement.

### PRIORITY CLAIM

This application claims benefit of priority to provisional Application No. 63/794,775 entitled “System and Method to Enable High Performance Between Python and Web Applications”, filed on Apr. 25, 2025, whose disclosure is hereby incorporated by reference in its entirety as though fully and completely set forth herein.

### TECHNICAL FIELD

The present invention relates to the field of programming, and more particularly to a system and method for facilitating Python programming for performing data measurements via a Web application.

### DESCRIPTION OF THE RELATED ART

Graphical programming has become a powerful tool available to programmers. Graphical programming environments and graphical programming interfaces (GPIs) such as the National Instruments LabVIEW™ product have become very popular. Tools such as LabVIEW™ have greatly increased the productivity of programmers, and increasing numbers of programmers are using graphical programming environments to develop their software applications. In particular, graphical programming tools are being used for test and measurement, data acquisition, process control, human machine interface (HMI), supervisory control and data acquisition (SCADA) applications, modeling, simulation, image processing / machine vision applications, and motion control, among others.

Engineers often will interface with a Web (i.e., internet-facing) Application and utilize a GPI to perform measurements and data acquisition on a device-under-test (DUT). During this process, large amounts of data may be transferred between different domains and translated into different formats, leading to undesirable latency and a heavy computational footprint. Accordingly, improvements in the field are desired.

### SUMMARY OF THE INVENTION

Various embodiments of a system and method are described herein for interworking between measurement function and JavaScript™ workflows, according to various embodiments.

In some embodiments, a measurement script is provided to a measurement device to perform a first measurement.

In some embodiments, first measurement results of the first measurement are received from the measurement device.

In some embodiments, the first measurement results are stored in a shared non-transitory computer-readable memory medium.

In some embodiments, the first measurement results are translated into a JavaScript™ Object Notation (JSON) text string, and the JSON text string is stored in the shared non-transitory computer-readable memory medium.

In some embodiments, a software module retrieves the JSON text string from the shared non-transitory computer-readable memory medium. The software module may utilize the JSON text string to display the first measurement results on a display device, and/or receive user input to modify parameters of the first measurement script for provision back to the measurement device for performing a modified measurement.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a computer system configured to execute a graphical program according to an embodiment of the present invention;

FIG. 2 illustrates an exemplary measurement setup for measuring performance of a device under test, according to some embodiments;

FIG. 3 is an exemplary block diagram of the computer systems of FIGS. 1 and 2, according to some embodiments;

FIG. 4 is a schematic illustration of traditional data movement between domains, according to the prior art;

FIG. 5 illustrates a distributed data workflow, according to some embodiments;

FIG. 6 illustrates a graphical programming interface (GPI) panel architecture, according to some embodiments;

FIG. 7 illustrates a high-level architecture for data movement implementing distributed data management services (DDMS), according to some embodiments; and

FIG. 8 is a flowchart diagram illustrating a method for interworking between measurement function and JavaScript™ workflows, according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### INCORPORATION BY REFERENCE

The following references are hereby incorporated by reference in their entirety as though fully and completely set forth herein:
U.S. Patent No. 4,914,568 titled "Graphical System for Modeling a Process and Associated Method," issued on Apr. 3, 1990.
U.S. Patent No. 5,481,741 titled “Method and Apparatus for Providing Attribute Nodes in a Graphical Data Flow Environment”.
U.S. Patent No. 6,173,438 titled “Embedded Graphical Programming System” filed Aug. 18, 1997.
U.S. Patent No. 6,219,628 titled “System and Method for Configuring an Instrument to Perform Measurement Functions Utilizing Conversion of Graphical Programs into Hardware Implementations,” filed Aug. 18, 1997.
U.S. Patent No. 7,210,117 titled “System and Method for Programmatically Generating a Graphical Program in Response to Program Information,” filed Dec. 20, 2000.

### Terms

The following is a glossary of terms used in the present application:

Memory Medium – Any of various types of non-transitory computer accessible memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium – a memory medium as described above, as well as a physical transmission medium, such as a bus, network, and/or other physical transmission medium that conveys signals such as electrical, electromagnetic, or digital signals.

Programmable Hardware Element - includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), ASICs (Application-Specific Integrated Circuits) and CPLDs (Complex PLDs). The programmable function blocks may range from fine grained (combinatorial logic or look up tables) to coarse grained (arithmetic logic units or processor cores). A programmable hardware element may also be referred to as "reconfigurable logic".

Software Program – the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program – a program, e.g., a netlist or bit file, that can be used to program or configure a programmable hardware element.

Program - the term “program” is intended to have the full breadth of its ordinary meaning. The term “program” includes 1) a software program which may be stored in a memory and is executable by a processor or 2) a hardware configuration program useable for configuring a programmable hardware element.

Graphical Program – A program comprising a plurality of interconnected nodes or icons, wherein the plurality of interconnected nodes or icons visually indicate functionality of the program. The interconnected nodes or icons are graphical source code for the program. Graphical function nodes may also be referred to as blocks.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW®, DasyLab™, DIADem™ and Matrixx/SystemBuild™ from National Instruments, Simulink® from the MathWorks, VEE™ from Agilent, WiT™ from Coreco, Vision Program Manager™ from PPT Vision, SoftWIRE™ from Measurement Computing, Sanscript™ from Northwoods Software, Khoros™ from Khoral Research, SnapMaster™ from HEM Data, VisSim™ from Visual Solutions, ObjectBench™ by SES (Scientific and Engineering Software), and VisiDAQ™ from Advantech, among others.

The term “graphical program” includes models or block diagrams created in graphical modeling environments, wherein the model or block diagram comprises interconnected blocks (i.e., nodes) or icons that visually indicate operation of the model or block diagram; exemplary graphical modeling environments include Simulink®, SystemBuild™, VisSim™, Hypersignal Block Diagram™, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected blocks or nodes are often referred to as the block diagram portion of the graphical program.

Node – In the context of a graphical program, an element that may be included in a graphical program. The graphical program nodes (or simply nodes) in a graphical program may also be referred to as blocks. A node may have an associated icon that represents the node in the graphical program, as well as underlying code and/or data that implements functionality of the node. Exemplary nodes (or blocks) include function nodes, sub-program nodes, terminal nodes, structure nodes, etc. Nodes may be connected together in a graphical program by connection icons or wires.

Data Flow Program – A Software Program in which the program architecture is that of a directed graph specifying the flow of data through the program, and thus functions execute whenever the necessary input data are available. Said another way, data flow programs execute according to a data flow model of computation under which program functions are scheduled for execution in response to their necessary input data becoming available. Data flow programs can be contrasted with procedural programs, which specify an execution flow of computations to be performed. As used herein "data flow" or "data flow programs" refer to "dynamically-scheduled data flow" and/or "statically-defined data flow".

Graphical Data Flow Program (or Graphical Data Flow Diagram) – A Graphical Program which is also a Data Flow Program. A Graphical Data Flow Program comprises a plurality of interconnected nodes (blocks), wherein at least a subset of the connections among the nodes visually indicate that data produced by one node is used by another node. A LabVIEW™ VI is one example of a graphical data flow program. A Simulink block diagram is another example of a graphical data flow program.

Graphical User Interface (or Graphical Programming Interface) – this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel – A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the HMI (Human Machine Interface) of a device. The user may adjust the controls on the front panel to affect the input and view the output on the respective indicators.

Graphical User Interface Element – an element of a graphical user interface, such as for providing input or displaying output. Exemplary graphical user interface elements comprise input controls and output indicators.

Input Control – a graphical user interface element for providing user input to a program. An input control displays the value input by the user and is capable of being manipulated at the discretion of the user. Exemplary input controls comprise dials, knobs, sliders, input text boxes, etc.

Output Indicator - a graphical user interface element for displaying output from a program. Exemplary output indicators include charts, graphs, gauges, output text boxes, numeric displays, etc. An output indicator is sometimes referred to as an “output control”.

Computer System – any of various types of computing or processing systems, including a personal computer system (PC), mainframe computer system, workstation, network appliance, Internet appliance, personal digital assistant (PDA), television system, grid computing system, or other device or combinations of devices. In general, the term "computer system" can be broadly defined to encompass any device (or combination of devices) having at least one processor that executes instructions from a memory medium.

Measurement Device - includes instruments, data acquisition devices, smart sensors, and any of various types of devices that are configured to acquire and/or store data. A measurement device may also optionally be further configured to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further configured to perform control functions, e.g., in response to analysis of the acquired or stored data. For example, the measurement device may send a control signal to an external system, such as a motion control system or to a sensor, in response to particular data. A measurement device may also be configured to perform automation functions, i.e., may receive and analyze data, and issue automation control signals in response.

Functional Unit (or Processing Element) – refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

Automatically – refers to an action or operation performed by a computer system (e.g., software executed by the computer system) or device (e.g., circuitry, programmable hardware elements, ASICs, etc.), without user input directly specifying or performing the action or operation. Thus the term "automatically" is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent – refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Wireless – refers to a communications, monitoring, or control system in which electromagnetic or acoustic waves carry a signal through space rather than along a wire.

Approximately – refers to a value being within some specified tolerance or acceptable margin of error or uncertainty of a target value, where the specific tolerance or margin is generally dependent on the application. Thus, for example, in various applications or embodiments, the term approximately may mean: within .1% of the target value, within .2% of the target value, within .5% of the target value, within 1%, 2%, 5%, or 10% of the target value, and so forth, as required by the particular application of the present techniques.

Proximate – near to; For example, proximate may mean within some specified distance, or within some specified fraction of a distance. Note that the actual threshold for being proximate is generally application dependent. Thus, in various applications, proximate may mean being within 1mm, 1 inch, 1 foot, 1 meter, 1 mile, etc. of some reference point or object, or may refer to being within 1%, 2%, 5%, 10%, etc., of a reference distance from some reference point or object.

Optimization – refers to the technical process of determining or selecting a best or improved element or configuration from a set of available alternatives with regard to some specified criteria (e.g., an objective function, and possibly constraints), and generally within some specified tolerance. Note that in practical use, an optimized system (or process) is improved (with respect to specified criteria), but may or may not be the absolute best or ideal solution. Said another way, optimization operates to improve a system or process, and may approach the mathematically optimum solution to within some tolerance, which may be dependent on the application, e.g., within 1%, 2%, 5%, 10%, etc., of the mathematically optimal solution. Thus, as used herein, the terms “optimized”, “optimum”, and “optimal” mean “improved with respect to specified criteria”.

Global Optimization – refers to a type of optimization in which a system or process with interdependent components or sub-processes is improved by varying multiple parameters or aspects of the system or process at the same time, generally with non-linear results. Note that ideal global optimization (finding the mathematically globally optimum solution) is generally intractable, because in even moderately complex systems and processes there are many more possible configurations and resulting behaviors than can be searched or considered in a reasonable amount of time. Thus, practically, global optimization operates to improve a complex system or process by varying multiple parameters concurrently, and may approach the mathematically globally optimum solution to within some tolerance, which may be dependent on the application, e.g., within 1%, 2%, 5%, 10%, etc., of the mathematically globally optimal solution. Thus, as used herein, the terms “globally optimized”, “globally optimum”, and “globally optimal” mean “globally improved with respect to specified criteria”. One example of a global optimization method is differential evolution, which optimizes a problem (system or process) via iterative improvement of candidate solutions with respect to some specified measure of quality.

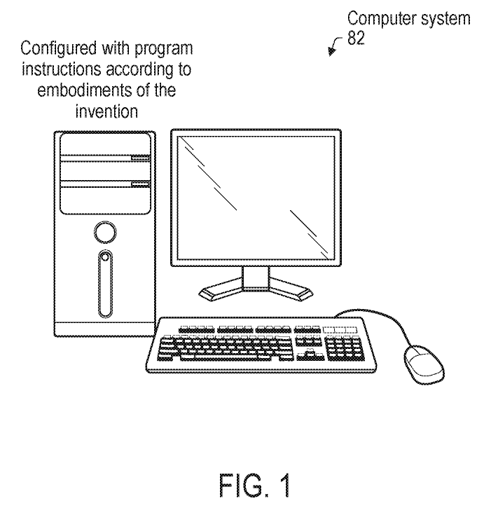

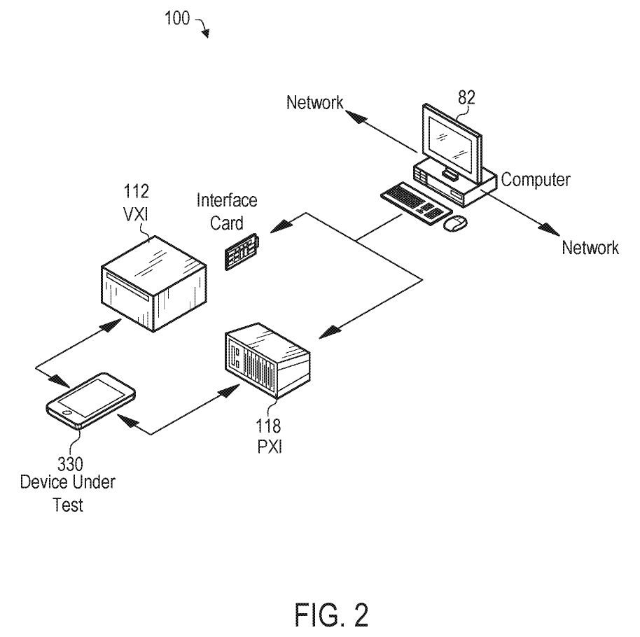

### FIGS. 1-2 – Computer System

FIG. 1 illustrates a computer system 82 configured to execute program instructions to facilitate interworking between measurement function and JavaScript™ workflows, according to some embodiments. As shown in FIG. 1, the computer system 82 may include a display device configured to display a graphical program as the graphical program is created and/or executed. The display device may also be configured to display a graphical user interface or front panel of the graphical program during execution of the graphical program. The graphical user interface may comprise any type of graphical user interface, e.g., depending on the computing platform.

The computer system 82 may include at least one memory medium on which one or more computer programs or software components according to one embodiment of the present invention may be stored. For example, the memory medium may store one or more graphical programs which are executable to perform the methods described herein. Additionally, the memory medium may store a graphical programming development environment application used to create and/or execute such graphical programs. The memory medium may also store operating system software, as well as other software for operation of the computer system. Various embodiments further include receiving or storing instructions and/or data implemented in accordance with the foregoing description upon a carrier medium.

FIG. 2 illustrates an exemplary system that is configured to perform measurements of a device under test (DUT), according to some embodiments presented herein. A computer 82 may be used by a user to conduct the measurement process, and may be connected to a network and to the measurement apparatus. In some embodiments, the computer may be connected to the measurement apparatus via a network, e.g., the internet, and the user may interface with a Web application to direct the measurement process. Software may be installed on a non-transitory memory medium of the computer to conduct the measurement process when executed by a processor of the computer. The computer 82 may be connected to any of a variety of signal generating apparatuses, according to various embodiments. For example, the computer may be connected to a PXI 118 with configurable interface cards. Alternatively or additionally, the computer may be connected to a VXI 112 that is configured with interface cards. The PXI 118 and/or the VXI 112 may serve as waveform generators to supply a signal to the Device Under Test (DUT) 330. The VXI and/or PXI may further function as a vector signal analyzer (VSA), to receive and analyze an output signal from the DUT. In other embodiments, the signal generator and/or signal analyzer may be comprised within the computer 82, which may be directly connected to the DUT 330.

Embodiments presented herein measure the electrical characteristics (e.g. radiofrequency (RF) performance, power added efficiency) of a device under test (DUT) to obtain measurement results. In some embodiments, the DUT 330 may be stimulated with a control signal (e.g. from an arbitrary waveform generator (AWG), a vector or RF signal generator (VSG, RFSG), which may be comprised within a PXI, VXI, a computer, or some other signal generator, in various embodiments). The timing of the AWG and VSG output signals may be aligned such that the DUT exhibits optimal electrical characteristics. In some embodiments, the signal characteristics may be measured with a vector signal analyzer (VSA), which may be comprised within any of a PXI, VXI, or other computer system.

In some embodiments, separate devices may be used to perform some of the functions (e.g. the AWG, VSG, VSA, etc.) described above. These dedicated devices, which may be known in the art as “box” type instruments, may also be connected to a computer system. In some embodiments, the connected computer system may be configured to receive outputs from or provide inputs to the dedicated instruments. The connected computer system may also, in some embodiments, collect and store data or display outputs from the devices.

The illustrated embodiment shows an exemplary system that may be used to perform calibration of a DUT. Calibration may be performed as a production test step during device manufacture or assembly. In some embodiments, system 100 may also be used for device characterization or production testing. In some embodiments, calibration may be performed to establish a suitable temporary condition for measurements. In other embodiments, measurements may be used for integration with the final product.

In the embodiments of FIGS. 1 and 2 above, one or more of the various devices may couple to each other over a network, such as the Internet. In one embodiment, the user operates to select a target device from a plurality of possible target devices for programming or configuration using a graphical program. Thus, the user may create a graphical program on a computer and use (execute) the graphical program on that computer or deploy the graphical program to a target device (for remote execution on the target device) that is remotely located from the computer and coupled to the computer through a network.

Graphical software programs which produce configuration files, perform data acquisition, analysis and/or presentation, e.g., for measurement, instrumentation control, industrial automation, modeling, or simulation, may be referred to as virtual instruments.

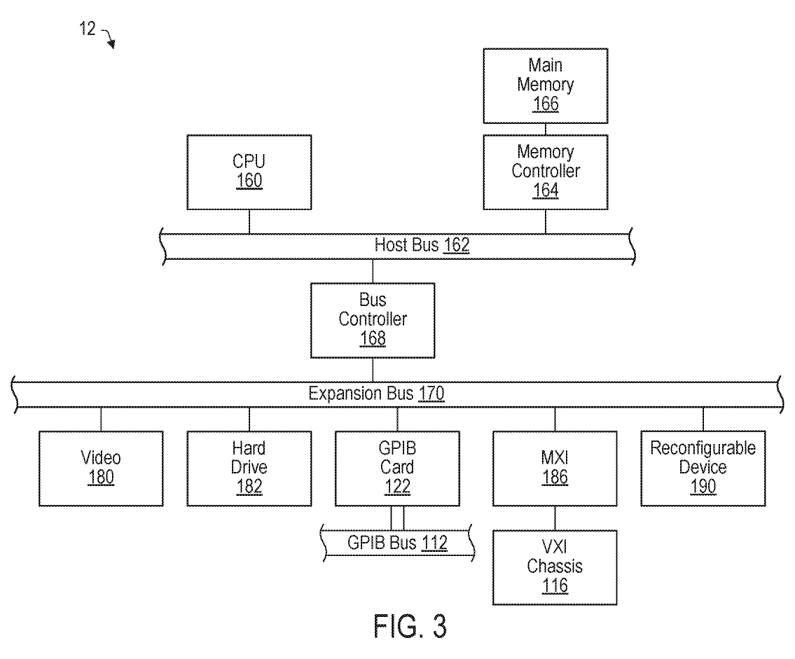

### FIG. 3 - Computer System Block Diagram

FIG. 3 is a block diagram 12 representing one embodiment of the computer system 82 illustrated in FIGS. 1 and 2. It is noted that any type of computer system configuration or architecture can be used as desired, and FIG. 3 illustrates a representative personal computer (PC) embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types of processors or multi-processor systems. A memory medium, typically comprising random access memory (RAM) and referred to as main memory, 166 is coupled to the host bus 162 by means of memory controller 164. The main memory 166 may store the graphical program according to described embodiments. The main memory may also store operating system software, as well as other software for operation of the computer system.

The host bus 162 may be coupled to an expansion bus 170 or input/output bus by means of a bus controller 168 or bus bridge logic. The expansion bus 170 may be the PCI (Peripheral Component Interconnect) expansion bus, although other bus types such as universal serial bus (USB) and Thunderbolt™ can also be used. The expansion bus 170 includes slots for various devices such as described above. The computer 82 further comprises a video display subsystem 180 and hard drive 182 coupled to the expansion bus 170. The computer 82 may also comprise a general purpose interface bus (GPIB) card 122 coupled to a GPIB bus 112, and/or an MXI device 186 coupled to a VXI chassis 116.

As shown, a reconfigurable device 190 may also be connected to the computer. The reconfigurable device 190 may comprise a programmable hardware element. The computer system may be configured to execute a graphical program to deploy a configuration file to the reconfigurable device 190.

### Performing Measurements on Measurement Devices Via Web Applications

Existing implementations for interfacing with and acquiring measurement data from a device-under-test (DUT) via a measurement device exhibit various undesirable qualities. In some cases, an interactive desktop measurement application is executed as a continuously running application that interacts with the user (e.g., an engineer), the measurement hardware, and/or the DUT. In some cases, a single shot measurement application may be used, which displays a soft (or hard) panel to configure measurements and /or data acquisitions prior to running the script. The panel may be utilized to visualize the results of the measurements and /or data acquisitions. In either case, the user configures parameters for instructions for the measurement device to perform one or more measurements on the DUT to obtain measurement data, provides these instructions to the measurement device to perform the measurement(s), and receives measurement results back from the measurement device. In some cases, particularly when the user is interfacing with a Web application that communicates with the measurement device over a network such as the internet, this process may involve moving large data files between the different domains of a database, server, browser, etc., and these data files may need to be translated into different file types (e.g., JavaScript™, JSON, HTML, Python™ code, etc.) during this process. This may introduce undesirable latency and computational overhead.

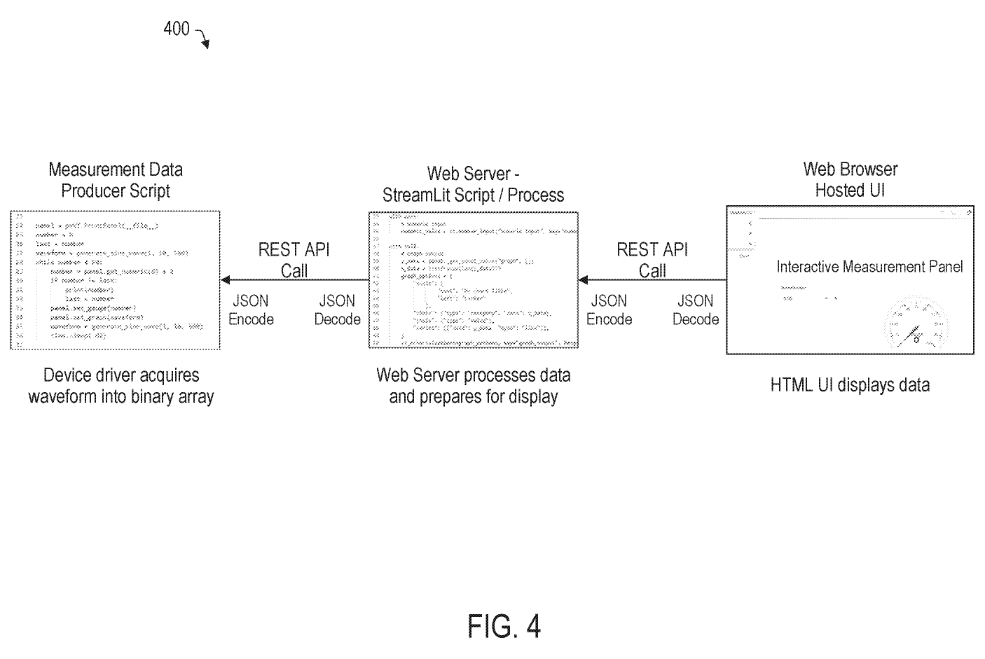

FIG. 4 is a schematic illustration of traditional data movement between domains, according to the prior art. As illustrated, a measurement data producer script (MDPS) may be prepared by an engineer that instructs a device driver of a measurement device to acquire a waveform from a DUT and store the results as a binary array. A web server executing a StreamLit script or similar process may provide a rest application programming interface (API) call to the MDPS. The web server may process data received from the MDPS and prepare the data for display on a display device. A web browser hosting a UI may display an interactive measurement panel, which utilizes a HyperText Markup Language (HTML) UI to display the data. The interactive measurement panel may be configured to receive user input from an engineer to configure parameters for measurement data acquisition. However, communications both between the web server and the MDPS and between the web browser and the web server may involve both decoding out of and encoding into JavaScript™ Object Notation (JSON), which may be time consuming and may involve a large computational overhead. In some implementations, a workflow may involve data being translated from a binary double array (in the measurement script), into a JSON text file, then back into a binary double array in a StreamLit Script, then back to JSON text, and then finally to JavaScript™.

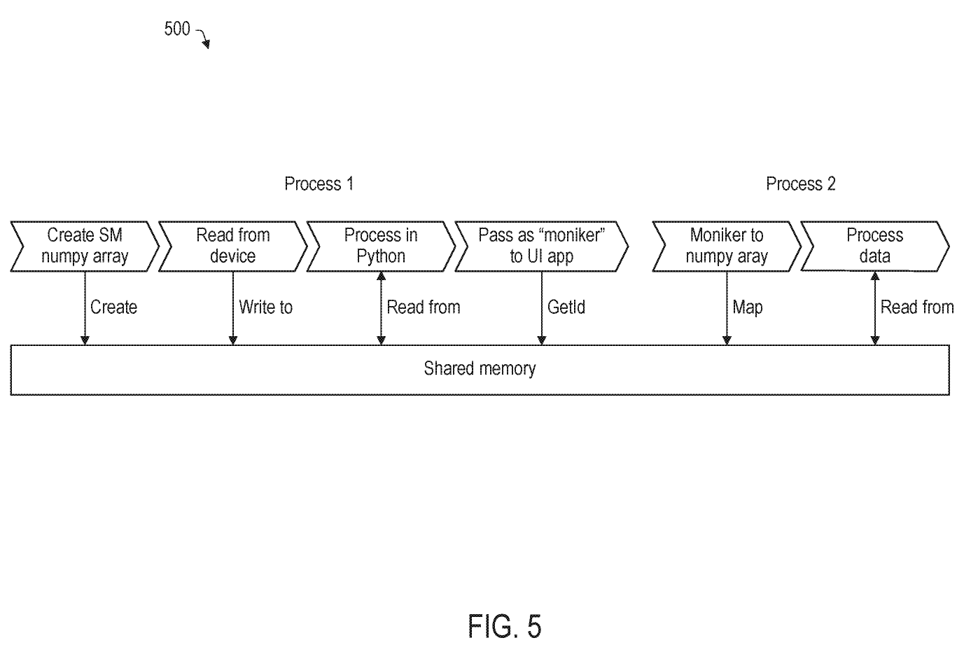

FIG. 5 illustrates a distributed data workflow that improves on legacy implementations, according to some embodiments. The illustrated workflow utilizes a shared memory between different computational and control modules to improve the efficiency and effectiveness of the workflow performance. In a first process (Process 1), a NumPy™ array is created, measurement reads from a device are written into the shared memory, data may be read from the shared memory and processed in Python, and/or a GetId moniker may be passed to a UI application. A second process (Process 2) is also illustrated, where a moniker is mapped to a NumPy™ array, and process data may be read from the shared memory. In some embodiments, the underlying transport mechanisms of the measurement data services are utilized to improve efficiency and performance. For example, DataMoniker may be used for passing data by reference, and DataMonikerService may be used for peer-to-peer data movement. In some embodiments, shared memory transport is utilized for zero copy access to raw data.

In some embodiments, a redistributable desktop application, which in some cases is Python™ based, may utilize a virtual instrument (VI) panel to interface with code written by a programmer. This VI panel may enable an engineer to interact with the panel without having to write explicit code for each panel event loop. Further, the event loop may be interactively reconfigured while executing, and after completion of a measurement or acquisition event, data inspection may be performed to refine the event parameters.

Embodiments herein describe systems and mechanisms for independent code with a live user interface (UI) that allows for interaction and reconfiguration before, during, and after code execution.

In some embodiments, further performance extensions for Python™ are utilized. For example, shared memory support may enable integration with a NumPy™ array. Custom controls may be created that directly communicate with the underlying data infrastructure. A custom Chrome Embedded Framework (CEF) host application may provide JavaScript™ direct access to the data infrastructure.

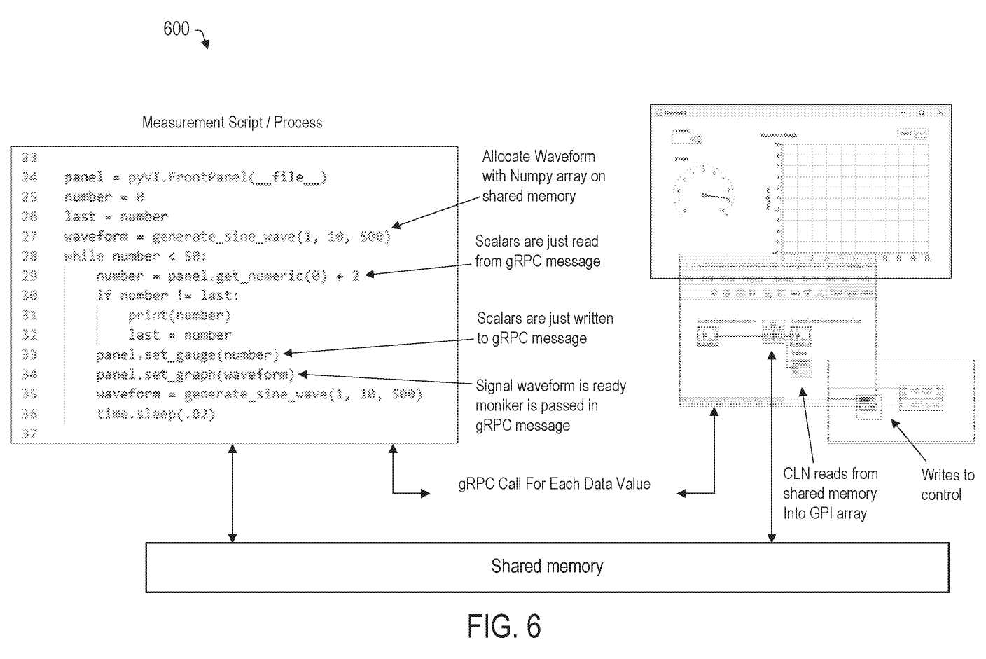

FIG. 6 illustrates a graphical programming interface (GPI) panel architecture, according to some embodiments. As illustrated, a measurement script or process has read and write access to shared memory. The measurement script includes parameters to specify a signal acquisition waveform to be allocated on a NumPy™ array stored in the shared memory. The signal acquisition waveform may be provided as a moniker and passed in a remote procedure call (RPC) message such as Google RPC (gRPC) or another RPC message. The measurement script also includes scalars that may be read from and written to an RPC message.

FIG. 6 further illustrates a GPI on the right (e.g., such as LabView™ or another GPI), which shows several displayed windows that an engineer may interact with to design graphical program instructions. The GPI may utilize a Call Library Node (CLN) to read data values from the shared memory and import them into the GPI array. Both the measurement script/process and the GPI may be configured to implement gRPC calls for data values.

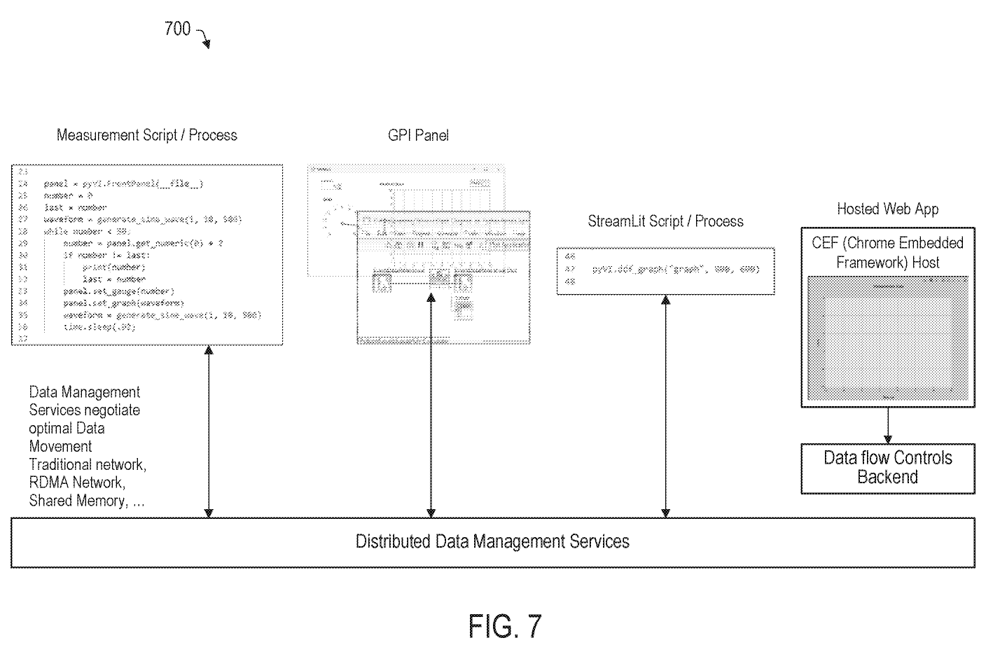

FIG. 7 illustrates a high-level architecture for data movement implementing distributed data management services (DDMS), according to some embodiments. The DDMS may have a shared memory instantiated thereon, to which various entities may have access. In addition to the measurement script/process and the GPI that are configured to read from and write to the shared memory of the DDMS, a StreamLit Script/Process may also be configured to read/write with the shared memory. In addition, a hosted web application hosted by a CEF host or another host may communicate with a data flow controls backend. The DDMS may negotiate optimal data movement through a traditional network, a remote direct memory access (RDMA) network, and/or through the shared memory.

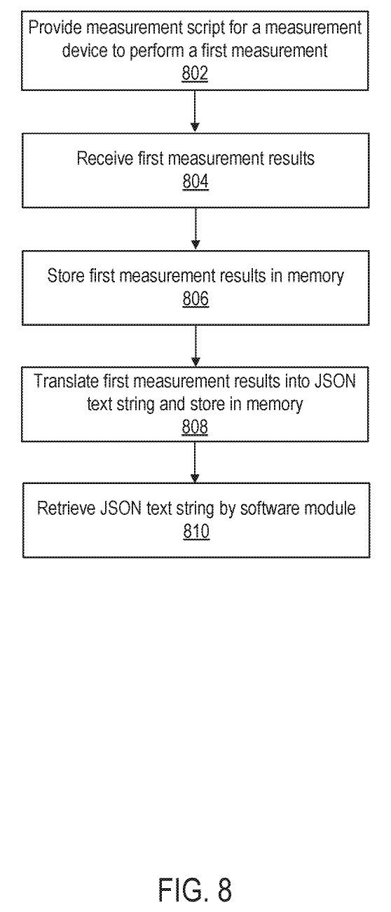

### FIG. 8 – Flowchart for Measurement Function and JavaScript™ Interworking

FIG. 8 is a flowchart diagram illustrating a method for interworking between measurement function and JavaScript™ workflows, according to some embodiments. The method shown in FIG. 8 may be used in conjunction with any of the computer systems or devices shown in the above Figures, among other devices. For example, the method may be performed by a processor executing program instructions stored on a non-transitory computer-readable memory medium.

In various embodiments, some of the method elements shown may be performed concurrently, in a different order than shown, or may be omitted. Additional method elements may also be performed as desired. As shown, this method may operate as follows.

At 802, a measurement script is provided to a measurement device to perform a first measurement. The measurement script may be instantiated as a text file that is machine-readable as instructions by a device driver of the measurement device, where the instructions direct the measurement device to perform the first measurement on the DUT according to one or more specified parameters. The measurement script may be developed by a user via a graphical programming interface (GPI) such as LabView™, or by another means.

At 804, first measurement results of the first measurement are received from the measurement device. The first measurement results may have been obtained by the measurement device from the DUT and then provided back to the computing system.

At 806, the first measurement results are stored in a shared non-transitory computer-readable memory medium. In some embodiments, the first measurement results are stored as a binary double array.

At 808, the first measurement results are translated into a JavaScript™ Object Notation (JSON) text string. The JSON text string may also be stored in the shared non-transitory computer-readable memory medium. In some embodiments, the first measurement results are also translated into a JavaScript™ file, and the JavaScript™ file are stored in the shared non-transitory computer-readable memory medium. As described in greater detail below, each of the (native format) first measurement results, the JSON text string, and the JavaScript™ file may be stored in the shared memory medium and may be accessible to a variety of domains, such as the measurement script, a web browser script, a GPI such as LabView™, and a StreamLit script, among other possibilities. Advantageously, the translation of the first measurement results into JSON and/or into JavaScript™ may only be performed once, and each of the domains may utilized the shared access to obtain the measurement data in a desired format without repeatedly encoding and decoding the measurement data.

For example, in some embodiments, a web browser script receives the first measurement results translated into JavaScript™ from the shared non-transitory computer-readable memory medium. In these embodiments, a display of a web browser may display a visual representation of the first measurement results using JavaScript™.

At 810, a software module retrieves the JSON text string from the shared non-transitory computer-readable memory medium. The software module may send a request for the JSON text string, and in response the computing system may provide the JSON text string to the software module via a wired or wireless means. In various embodiments, the software module is a StreamLit script, a LabVIEW™ application; or a web browser script. In some embodiments, the shared non-transitory computer-readable memory medium has shared access for both the measurement device and the software module.

In some embodiments, user input is received via the software module to modify one or more parameters of the first measurement. A modified measurement script may be constructed based on the modified parameters of the first measurement. The software module may provide the modified parameters to the computing device in a particular file format, such as GPI code, a StreamLit script, an HTML file, etc., and the computing device may translate the received data into a machine-readable modified measurement script. In some embodiments, the modified measurement script may be provided to the measurement device to cause the measurement device to perform a second measurement with the modified one or more parameters. The computing device may receive, from the measurement device, second measurement results of the second measurement. The second measurement results may be stored in the shared non-transitory computer-readable memory medium. The second measurement results may be translated into a second JSON text string and/or into a second JavaScript™ file, and these may also be stored in the shared memory.

In some embodiments, the measurement device and the software module are configured to communicate with the shared memory medium using a plurality of networks. The method may further include determining, by a control module, a first network of the plurality of networks for performing communications between the measurement script and the software module. The control module may be instantiated by a processor executing program instructions, and it may implement automatic detection and selection of data transmission strategies, to improve efficiency and performance. For example, the computing device may be connected over multiple networks with different speeds, and the control module may select a network for transmitting data based on the size of the data transfer, the speed of each respective network, and a latency tolerance (e.g., in some cases the control module may select the slowest network that satisfies the latency tolerance for a particular data size). In some embodiments, the first network is selected based on a communication transport protocol of the first network. Different network may support different communication transport protocols, and the control module may select a network with a suitable transport protocol for a particular data transfer. Note that the control module may perform network selection for any one or more of the data transfers between the software module, the measurement device, and the shared memory medium.

In some embodiments, a parallel distributed data flow may be implemented, where a data movement bus in the shared memory may be utilized to facilitate multiple concurrent data transfers.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
providing a measurement script to a measurement device to perform a first measurement;
receiving, from the measurement device, first measurement results of the first measurement;
storing the first measurement results in a shared non-transitory computer-readable memory medium;
translating the first measurement results into a JavaScript™ Object Notation (JSON) text string;
storing the JSON text string in the shared non-transitory computer-readable memory medium; and
retrieving, by a software module, the JSON text string from the shared non-transitory computer-readable memory medium.

2. The method of claim 1, further comprising:
translating the first measurement results into JavaScript™ and storing the first measurement results translated into JavaScript™ in the shared non-transitory computer-readable memory medium.

3. The method of claim 2, further comprising:
retrieving, by a web browser script, the first measurement results translated into JavaScript™ from the shared non-transitory computer-readable memory medium; and
displaying, on a display of a web browser and using JavaScript™, a visual representation of the first measurement results.

4. The method of claim 1, further comprising:
receiving, via the software module, user input to modify one or more parameters of the first measurement;
modifying the measurement script based on the modified one or more parameters of the first measurement to obtain a modified measurement script;
providing the modified measurement script to the measurement device to cause the measurement device to perform a second measurement with the modified one or more parameters;
receiving, from the measurement device, second measurement results of the second measurement; and
storing the second measurement results in the shared non-transitory computer-readable memory medium.

5. The method of claim 1,
wherein the first measurement results are stored as a binary double array.

6. The method of claim 1, wherein the measurement device and the software module are configured to communicate with the shared non-transitory computer-readable memory medium using a plurality of networks, the method further comprising:
determining, by a control module, a first network of the plurality of networks for performing communications between the shared non-transitory computer-readable memory medium and one or both of the measurement device and the software module.

7. The method of claim 6,
wherein the first network is selected based on a communication transport protocol of the first network.

8. The method of claim 7,
wherein the shared non-transitory computer-readable memory medium has shared access for the measurement script and the software module.

9. The method of claim 1,
wherein the software module comprises:
a StreamLit script;
a graphical programming interface (GPI);
a LabVIEW™ application; or
a web browser script.

10. A non-transitory computer-readable memory medium comprising program instructions which, when executed by a processor, cause a computing device to:
provide a measurement script to a measurement device to perform a first measurement;
receive, from the measurement device, first measurement results of the first measurement;
store the first measurement results in the non-transitory computer-readable memory medium;
translate the first measurement results into a JavaScript™ Object Notation (JSON) text string;
store the JSON text string in the non-transitory computer-readable memory medium; and
retrieve, by a software module, the JSON text string from the non-transitory computer-readable memory medium.

11. The non-transitory computer-readable memory medium of claim 10, wherein the program instructions are further executable to cause the computing device to:
translate the first measurement results into JavaScript™; and
store the first measurement results translated into JavaScript™ in the non-transitory computer-readable memory medium.

12. The non-transitory computer-readable memory medium of claim 11, wherein the program instructions are further executable to cause the computing device to:
retrieve, by a web browser script, the first measurement results translated into JavaScript™ from the non-transitory computer-readable memory medium; and
display, on a display of a web browser and using JavaScript™, a visual representation of the first measurement results.

13. The non-transitory computer-readable memory medium of claim 10, wherein the program instructions are further executable to cause the computing device to:
receive, via the software module, user input to modify one or more parameters of the first measurement;
modify the measurement script based on the modified one or more parameters of the first measurement to obtain a modified measurement script;
provide the modified measurement script to the measurement device to cause the measurement device to perform a second measurement with the modified one or more parameters;
receive, from the measurement device, second measurement results of the second measurement; and
store the second measurement results in the non-transitory computer-readable memory medium.

14. The non-transitory computer-readable memory medium of claim 10,
wherein the first measurement results are stored as a binary double array.

15. The non-transitory computer-readable memory medium of claim 10, wherein the measurement device and the software module are configured to communicate with the non-transitory computer-readable memory medium using a plurality of networks, wherein the program instructions are further executable to cause the computing device to:
determine, by a control module, a first network of the plurality of networks for performing communications between the non-transitory computer-readable memory medium and one or both of the measurement device and the software module.

16. The non-transitory computer-readable memory medium of claim 15,
wherein the first network is selected based on a communication transport protocol of the first network.

17. The non-transitory computer-readable memory medium of claim 16,
wherein the non-transitory computer-readable memory medium has shared access for the measurement script and the software module.

18. The non-transitory computer-readable memory medium of claim 10,
wherein the software module comprises:
a StreamLit script,
a LabVIEW™ application; or
a web browser script.

19. An apparatus, comprising:
a processor coupled to a non-transitory computer-readable memory medium,
wherein the non-transitory computer-readable memory medium stores program instructions that are executable by the processor to cause a computing device to:
provide a measurement script to a measurement device to perform a first measurement;
receive, from the measurement device, first measurement results of the first measurement;
store the first measurement results in the non-transitory computer-readable memory medium;
translate the first measurement results into a JavaScript™ Object Notation (JSON) text string;
store the JSON text string in the non-transitory computer-readable memory medium; and
retrieve, by a software module, the JSON text string from the non-transitory computer-readable memory medium.

20. The apparatus of claim 19, wherein the program instructions are further executable to cause the computing device to:
translate the first measurement results into JavaScript™; and
store the first measurement results translated into JavaScript™ in the non-transitory computer-readable memory medium.
